(19) United States
(12) Patent Application Publication
(10) Pub. No.: US 2014/0010365 A1
(43) Pub. Date: Jan. 9, 2014

(54) REPLACEABLE ENCRYPTION KEY PROVISIONING

(71) Applicants: Vincent Von Bokern, Rescue, CA (US); Daniel Nemiroff, Folsom, CA (US)

(72) Inventors: Vincent Von Bokern, Rescue, CA (US); Daniel Nemiroff, Folsom, CA (US)

(21) Appl. No.: 13/543,453

(22) Filed: Jul. 6, 2012

(51) Int. Cl. H04L 9/08

(52) U.S. Cl. CPC H04L 9/0861
USPC 380/44

(57) ABSTRACT

Embodiments of an invention for replaceable encryption key provisioning are disclosed. In one embodiment, a processor includes a global key, encryption hardware, and firmware. The encryption hardware is to perform an encryption algorithm using the global key, wherein the global key is accessible only as an input to the encryption hardware. The firmware is to store a constant and instructions to cause the encryption hardware to generate a private key by decrypting the constant using the global key.

### BACKGROUND

1. Field

The present disclosure pertains to the field of information processing, and more particularly, to the field of encrypting information.

2. Description of Related Art

In an information processing system, secret information may be protected from discovery by encrypting it. In private key encryption algorithms, such as the advanced encryption standard (“AES”) defined in Federal Information Processing Standard 197 from the National Institute of Standards and Technology, use a private key to transform unencrypted information (“plain-text”) into encrypted information (“cipher-text”) that generally has no meaning unless subsequently decrypted by a reverse transformation using the private key. In public key encryption algorithms, such as that developed by Rivest, Shamir, and Adelman (“RSA”), two keys are used, one a public key and the other a private key. The public key may be made publicly available for encrypting information, and the private key is kept secret to be used to decrypt information encrypted with the corresponding public key.

In either case, the private key may be embedded in the information processing system; for example, it may be programmed into fuses in a processor or other system component.

### BRIEF DESCRIPTION OF THE FIGS.

The present invention is illustrated by way of example and not limitation in the accompanying figures.

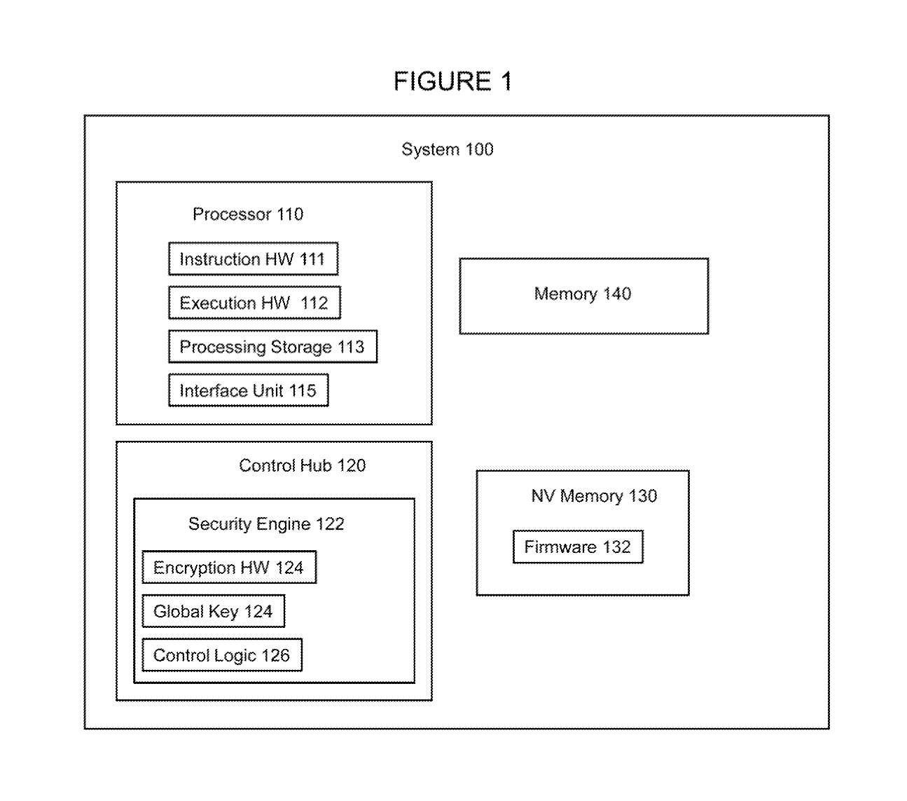

FIG. 1 illustrates a system including replaceable encryption key provisioning according to an embodiment of the present invention.

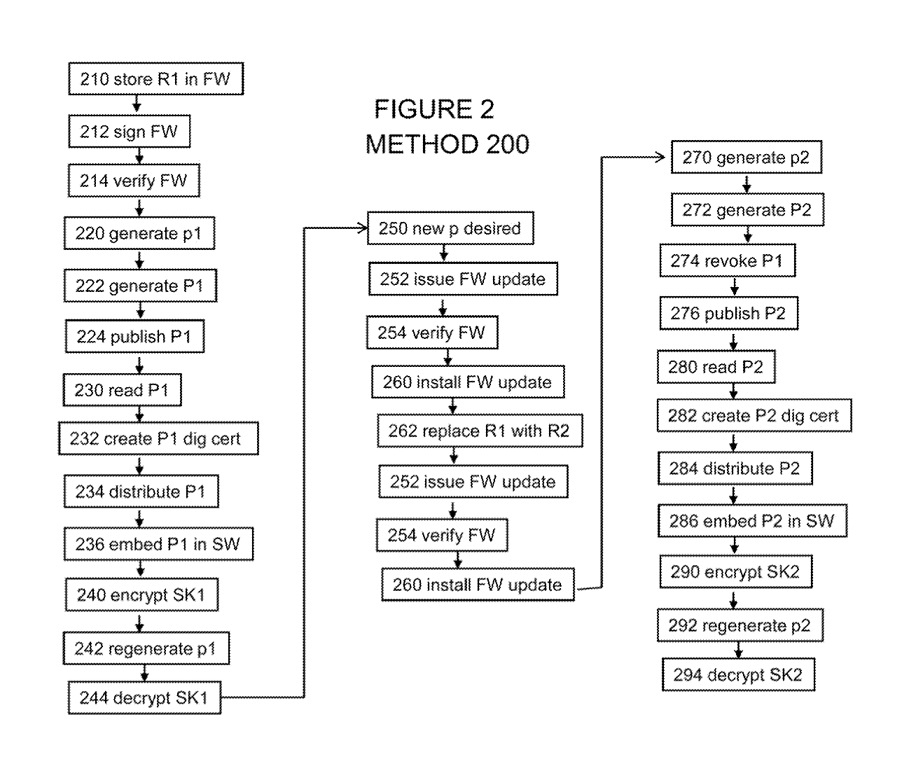

FIG. 2 illustrates a method for replaceable encryption key provisioning according to an embodiment of the present invention.

### DETAILED DESCRIPTION

Embodiments of an invention for replaceable encryption key provisioning are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

As described in the background section, encryption using a private key embedded in a processor or other system component may be used to protect secret information. However, if the private key is discovered, the system may no longer be able to protect secret information. Therefore, embodiments of the present invention may be desirable to provide new private keys as needed. Furthermore, one or more applications running on an information processing system may require more than one unique private key, so embodiments of the present invention may be desirable to provide additional private keys as needed.

FIG. 1 illustrates system 100, an information processing system in which an embodiment of the present invention may be present and/or operate. System 100 may represent any type of information processing system, such as a server, a desktop computer, a portable computer, a set-top box, a hand-held device, or an embedded control system. System 100 includes processor 110, control hub 120, non-volatile memory 130, and system memory 140. Systems embodying the present invention may include any number of each of these components and any other components or other elements, such as peripherals and/or input/output devices. Any or all of the components or other elements in any system embodiment may be connected, coupled, or otherwise in communication with each other through any number of buses, point-to-point, or other wired or wireless connections.

Processor 110 may be any type of processor, including a general purpose microprocessor, such as a processor in the Intel® Core® Processor Family, Intel® Atom® Processor Family, or other processor family from Intel® Corporation, or another processor from another company, or a special purpose processor or microcontroller. Processor 110 may include multiple threads and multiple execution cores, in any combination. Processor 110 includes instruction hardware 111, execution hardware 112, processing storage 113, interface unit 114, and control logic 115. Processor 110 may also include any other circuitry, structures, or logic not shown in FIG. 1.

Instruction hardware 111 may represent any circuitry, structure, or other hardware, such as an instruction decoder, for fetching, receiving, decoding, and/or scheduling instructions. Any instruction format may be used within the scope of the present invention; for example, an instruction may include an opcode and one or more operands, where the opcode may be decoded into one or more micro-instructions or micro-operations for execution by execution hardware 112.

Execution hardware 112 may include any circuitry, structure, or other hardware, such as an arithmetic unit, logic unit, floating point unit, shifter, etc., for processing data and executing instructions, micro-instructions, and/or micro-operations.

Processing storage 113 may represent any type of storage usable for any purpose within processor 110; for example, it may include any number of data registers, instruction registers, status registers, other programmable or hard-coded registers or register files, or any other storage structures.

Interface unit 114 may represent any circuitry, structure, or other hardware, such as a bus unit or any other unit, port, or interface, to allow processor 110 to communicate with other components in system 100 through any type of bus, point to point, or other connection, directly or through any other component, such as a memory controller or a bus bridge.

Control logic 115 may include any circuitry, logic, or other structures, including microcode, state machine logic, and programmable logic, to control the operation of the units and other elements of processor 110 and the transfer of data within, into, and out of processor 110. Control logic 115 may cause processor 110 to perform or participate in the performance of method embodiments of the present invention, such as the method embodiments described below, for example, by causing processor 110 to execute instructions received by instruction hardware 111 and micro-instructions or micro-operations derived from instructions received by instruction hardware 111.

Control hub 120 may include any logic, circuitry, or other hardware to control the transfer of information between processor 110, non-volatile memory 130, system memory 140, and any other components in information processing system 100. Control hub 120 may also include embedded security engine 122, including encryption hardware 124, global key 126, and control logic 128. Control hub 120 may also include any other circuitry, structures, or logic not shown in FIG. 1.

Encryption hardware 124 may include any circuitry or other structures to execute one or more encryption algorithms, and the corresponding decryption algorithms. In one embodiment, encryption hardware 124 includes circuitry to perform the AES algorithm in Electronic Code Book (ECB) mode.

Global key (G) 126 may be any encryption key stored in non-volatile storage, such as a read-only memory implemented in fuses. In one embodiment, global key 126 is a symmetric key stored in synthesized gates. Global key 126 is not available to be read by software or firmware; it may only be selected as an input to encryption hardware 124.

Control logic 128 may include any circuitry, logic, or other structures, including microcode, state machine logic, and programmable logic, to control the operation of control hub 120 and the transfer of data within, into, and out of control hub 120. Control logic 128 may cause control hub 120 to perform or participate in the performance of method embodiments of the present invention, such as the method embodiments described below.

Although the embodiment of FIG. 1 shows embedded security engine 122 included in control hub 120, part or all of embedded security engine 120 may be included in a separate component, such as processor 110.

Non-volatile memory 130 may represent any type of non-volatile memory, such as flash memory. Non-volatile memory 130 includes firmware 132, which may include data and/or instructions. Data stored in firmware 132 may include a constant ‘R’ to be used in method embodiments of the present invention; in one embodiment, R may be a 128-bit constant. Instructions stored in firmware 132 may cause processor 110 and/or embedded security engine 122 to perform or participate in the performance of method embodiments of the present invention, such as the method embodiments described below.

System memory 140 may include dynamic random access memory and/or any other type of medium accessible by processor 110, and may be used to store data and/or instructions used or generated by processor 110 and/or any other components.

FIG. 2 illustrates method 200 for replaceable encryption key provisioning according to an embodiment of the present invention. Although method embodiments of the invention are not limited in this respect, reference may be made to elements of FIG. 1 to help describe the method embodiment of FIG. 2.

In box 210 of method 200, constant R1 may be stored in firmware 132, for example, by the manufacturer or vendor of system 100. In box 212, a digital signature is generated for firmware 132, including constant R1, where the digital signature may be used to verify that firmware 132 is authentic. In box 214, embedded security engine 122 uses the digital signature to verify that firmware 132 is authentic.

In box 220, instructions from firmware 132 are executed to cause embedded security engine 122 to generate private key ‘p1’ by decrypting. ‘R1’ using ‘G’, for example, according to a symmetric decryption algorithm such as AES in ECB mode. In box 222, instructions from firmware 132 are executed to cause embedded security engine 122 to generate public key ‘P1’ corresponding to private key ‘p1’. In box 224, public key ‘P1’ is made externally available, for example, by storing public key ‘P1’ in processing storage 113, system memory 140, or other storage accessible to software.

In box 230, public key ‘P1’ is read, for example, by the manufacturer or vendor of system 100. In box 232, public key ‘P1’ is stored, for example, by the manufacturer or vendor of system 100, in a signed digital certificate, for example, in x.509 format. In box 234, the digital certificate including public key ‘P1’ is distributed to software developers. In box 236, a software developer embeds public key ‘P1’ in a software product.

In box 240, the software, running on system 100, encrypts secret information, such as a session key (SKI), using public key ‘P1’. In box 242, embedded security engine 122 re-generates private key ‘p1’ by decrypting ‘R1’ using ‘G.’ In box 244, embedded security engine uses private key ‘p1’ to decrypt the secret information.

In box 250, a second private key is desired, for example, because private key ‘p1’ has been discovered. In box 252, a signed firmware update, including constant ‘R2,’ is issued, for example, by the manufacturer or vendor of system 100. In box 254, embedded security engine 122 uses the digital signature to verify that firmware 132 is authentic.

In box 260, the firmware update is installed in system 100, for example, by the owner, administrator, or user of system 100. In box 262, installation of the firmware update causes constant R2 to be stored in firmware 132. In one embodiment, R2 may replace R1.

In box 270, instructions from firmware 132 are executed to cause embedded security engine 122 to generate private key ‘p2’ by decrypting ‘R2’ using ‘G’. In box 272, instructions from firmware 132 are executed to cause embedded security engine 122 to generate public key ‘P2’ corresponding to private key ‘p2’. In box 274, public key ‘P1’ is revoked, for example, by the manufacturer or vendor of system 100 issuing a Certificate Revocation List. In box 276, public key ‘P2’ is made externally available, for example, by storing public key ‘P2’ in processing storage 113, system memory 140, or other storage accessible to software.

In box 280, public key ‘P2’ is read. In box 282, public key ‘P2’ is stored in a signed digital certificate. In box 284, the digital certificate including public key ‘P2’ is distributed to software developers. In box 286, a software developer embeds public key ‘P2’ in a software product.

In box 290, the software, running on system 100, encrypts secret information, such as a session key (SK2), using public key ‘P2’. In box 292, embedded security engine 122 re-generates private key ‘p2’ by decrypting ‘R2’ using ‘G.’ In box 294, embedded security engine uses private key ‘P1’ to decrypt the secret information.

Within the scope of the present invention, the method illustrated in FIG. 2 may be performed in a different order, with illustrated boxes omitted, with additional boxes added, or with a combination of reordered, omitted, or additional boxes. For example, box 264, the revocation of public key ‘P1’, may be omitted if, in box 250, a second private key is desired even though private key ‘p1’ has not been discovered.

Embodiments or portions of embodiments of the present invention, as described above, may be stored in any form of a machine-readable medium. For example, all or part of method 200 may be embodied in software or firmware instructions that are stored on a medium readable by processor 110, which when executed by processor 110, cause processor 110 to execute an embodiment of the present invention.

Thus, embodiments of an invention for replaceable encryption key provisioning have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a global key;
encryption hardware to perform an encryption algorithm using the global key, wherein the global key is accessible only as an input to the encryption hardware; and
firmware to store a constant and instructions to cause the encryption hardware to generate a private key by decrypting the constant using the global key.

2. The processor of claim 1, wherein the global key is stored in synthesized gates.

3. The processor of claim 1, wherein the encryption algorithm is an advanced encryption standard (AES) algorithm.

4. A method comprising:
storing a first constant in firmware; and
providing a first private key by decrypting, by encryption hardware, the first constant using a global key accessible only as an input to the encryption hardware.

5. The method of claim 4, wherein the encryption operation is an advanced encryption standard (AES) operation.

6. The method of claim 4, further comprising generating a first public key corresponding to the first private key.

7. The method of claim 6, further comprising encrypting first information using the first public key.

8. The method of claim 7, further comprising re-generating the first private key by decrypting, by the encryption hardware, the first constant using the global key.

9. The method of claim 8, further comprising decrypting, by the encryption hardware, the first information using the first private key.

10. The method of claim 4, further comprising issuing a firmware update to store a second constant in the firmware.

11. The method of claim 10, further comprising providing a second private key by decrypting, by encryption hardware, the second constant using the global key.

12. The method of claim 11, further comprising generating a second public key corresponding to the second private key.

13. The method of claim 12, further comprising encrypting second information using the second public key.

14. The method of claim 13, further comprising revoking the first public key.

15. A machine-readable medium including instructions that, when executed, cause a processor to:
provide a first private key by decrypting, using encryption hardware, a first firmware constant with a global key accessible only as an input to the encryption hardware.

16. The machine-readable medium of claim 15, also including instructions that cause the processor to generate, using the encryption hardware, a first public key corresponding to the first private key.

17. The machine-readable medium of claim 16, also including instructions that cause the processor to re-generate the first private key by decrypting, using the encryption hardware, the first constant with the global key.

18. The machine-readable medium of claim 16, also including instructions that cause the processor to decrypt, using the encryption hardware, the first information with the first private key.

19. The machine-readable medium of claim 18, also including instructions that cause the processor to provide a second private key by decrypting, using the encryption hardware, a second firmware constant using the global key.

20. The machine-readable medium of claim 19, wherein the second private key replaces the first private key.
